(19) United States
(12) Patent Application Publication
(10) Pub. No.: US 2026/0307255 A1
(43) Pub. Date: Oct. 8, 2026

(54) METHOD FOR AUTOMATIC COLLISION AND OVERLOAD DETECTION AND RECOVERY OF COLLABORATIVE ROBOT, AND COMPUTER PROGRAM RECORDED ON RECORD-MEDIUM FOR EXECUTING METHOD THEREFOR

(71) Applicant: BRILS Co., Ltd., Incheon (KR)

(72) Inventor: Jin JEON, Incheon (KR)

(21) Appl. No.: 19/638,286

(22) Filed: Apr. 3, 2026

(30) Foreign Application Priority Data
Apr. 4, 2025 (KR) 10-2025-0044383

(51) Int. Cl. B25J 9/16

(52) U.S. Cl. CPC B25J 9/1674; B25J 9/1682

(57) ABSTRACT

An embodiment relates to a method for automatic collision and overload detection and recovery of a collaborative robot. The method may include determining, by a management server, whether a collision has occurred based on a torque load applied to the collaborative robot, and controlling, by the management server, the collaborative robot according to whether the collision has been determined to have occurred.

### CROSS REFERENCE TO RELATED APPLICATION

The present application claims priority to Korean Patent Application No. 10-2025- 0044383, filed Apr. 04, 2025, the entire contents of which are incorporated here for all purposes by this reference.

### TECHNICAL FIELD

The present disclosure relates to a safety management system for a collaborative robot. More particularly, the present disclosure relates to a method for automatic collision and overload detection and recovery of a collaborative robot, capable of detecting a collision and an overload situation that may occur during operation of the collaborative robot, and to a computer program recorded on a recording medium for executing the method.

### BACKGROUND

A logistics automation system refers to a system that automates packaging, sorting, stacking, and transfer processes of goods for the purpose of improving logistics efficiency through convergence of Internet of Things (IoT) technology, robot technologies such as autonomous driving, and artificial intelligence technologies for environment recognition, situation recognition, and work planning through learning, in logistics centers, factories, and the like.

A collaborative robot is a robot based on the concept of a partner that collaborates with a human in a space not separated from the human, and has recently attracted attention due to advantages of relatively low cost and rapid applicability in various industrial fields. In addition, the collaborative robot has advantages over a conventional industrial robot in terms of ease of operation and ease of process rearrangement, and thus can be flexibly utilized for various processes and tasks. Recently, unlike an industrial robot that mainly performs simple repetitive tasks, the collaborative robot has served as a fusion system in which information and communication technology (IT) technologies such as artificial intelligence, a human interface, and a ubiquitous network are integrated.

In order to implement collaborative work between a human and a robot using the collaborative robot, three characteristic factors, namely safety, coexistence, and collaboration, should be satisfied. In particular, safety refers to an ability to avoid a collision with a worker or to detect a collision and avoid a risk resulting from the collision in an unavoidable collision.

Recently, in order to secure safety in implementing collaborative work between a collaborative robot and a human, it has been prescribed that a fence or a sensitive protective device be installed in a work area. However, such measures alone have been insufficient to secure worker safety.

In order to solve these problems, various collision detection systems for automatically detecting a collision of a collaborative robot have been developed. However, most conventional collision detection systems rely on a method of stopping work, and have had a problem in that, for recovery, a user has to directly intervene to inspect a robot state and perform an initialization process. As a result, work productivity may be reduced, and, in the case of an unskilled worker, an appropriate response may be delayed.

### PRIOR ART DOCUMENT

### Patent Document

Patent Document: Korean Patent Publication No. 10-2024-0094181, ‘Logistics Automation Robot’, (published Jun. 25, 2024)

### SUMMARY

An object of the present disclosure is to provide a method for automatic collision and overload detection and recovery of a collaborative robot, capable of detecting a collision and an overload situation that may occur during operation of the collaborative robot.

Another object of the present disclosure is to provide a computer program, recorded on a recording medium, for executing the method for automatic collision and overload detection and recovery of a collaborative robot, capable of detecting a collision and an overload situation that may occur during operation of the collaborative robot.

Technical problems of the present disclosure are not limited to those described above, and other technical problems not described herein will be clearly understood by those skilled in the art from the following description.

In order to achieve the technical problems described above, the present disclosure provides a method for automatic collision and overload detection and recovery of a collaborative robot, capable of detecting a collision and an overload situation that may occur during operation of the collaborative robot, the method comprising: determining, by a management server, whether a collision has occurred based on a torque load applied to the collaborative robot; and controlling, by the management server, the collaborative robot according to whether the collision has been determined to have occurred.

More specifically, the determining may comprise receiving a current value generated in at least one driving unit for rotating or moving a plurality of joints included in the collaborative robot, and estimating, based on the received current value, a torque load applied to the at least one driving unit.

The determining may comprise receiving, from a torque sensor installed at each joint of the collaborative robot, a torque load applied to each joint.

The determining may comprise determining that the collaborative robot has collided when a torque load of at least one joint among a plurality of joints included in the collaborative robot exceeds a preset value.

The controlling may comprise stopping operation of the collaborative robot when it is determined that the collaborative robot has collided.

The controlling may comprise, when it is determined that the collaborative robot has collided, identifying, among a plurality of joints included in the collaborative robot, a joint affected by the collision, and moving the identified joint by a preset distance in a direction opposite to a direction of movement at a time of the collision.

The controlling may comprise identifying, as the joint affected by the collision, a joint having a greatest torque load among the plurality of joints.

The controlling may comprise, when it is determined that the collaborative robot has collided, moving each of the plurality of joints included in the collaborative robot by a preset distance in a direction opposite to a direction of movement at a time of the collision.

The controlling may comprise, when it is determined that the collaborative robot has collided, cumulatively storing torque loads generated in each of the plurality of joints included in the collaborative robot, and predicting a maintenance timing for each of the plurality of joints based on the cumulatively stored torque loads.

The controlling may comprise predicting that a maintenance timing for a corresponding joint has arrived when a sum of torque loads cumulatively stored for each of the plurality of joints exceeds a preset value.

The controlling may comprise identifying a type of collision object based on a magnitude of the torque load applied to the collaborative robot, and differently controlling operation of the collaborative robot according to the identified type of collision object.

The controlling may comprise, when the identified collision object is another collaborative robot, receiving status information from the other collaborative robot and resuming operation according to the received status information.

In order to achieve the technical problems described above, the present disclosure also provides a computer program, recorded on a recording medium, for executing the method, wherein the computer program may be combined with a computing device including a memory, a transceiver, and a processor configured to process instructions resident in the memory, and may cause the processor to execute determining whether a collision has occurred based on a torque load applied to a collaborative robot and controlling the collaborative robot according to whether the collision has been determined to have occurred.

Specific details of other embodiments are included in the detailed description and the drawings.

According to various embodiments of the present disclosure, a collision situation that may occur during operation of a collaborative robot may be detected in real time, and operation of the collaborative robot may be automatically controlled when the situation occurs, thereby preventing equipment damage and worker safety accidents and improving work efficiency.

Effects of the present disclosure are not limited to those described above, and other effects not described herein will be clearly understood by those skilled in the art from the claims.

### BRIEF DESCRIPTION OF THE DRAWINGS

FIG. 1 is a configuration diagram of a safety management system according to an embodiment of the present disclosure.

FIG. 2 is a logical configuration diagram of a management server according to an embodiment of the present disclosure.

FIGS. 3 and 4 are exemplary diagrams for explaining a collision of a collaborative robot according to an embodiment of the present disclosure.

FIGS. 5 and 6 are exemplary diagrams for explaining a graphical user interface (GUI) according to an embodiment of the present disclosure.

FIG. 7 is a hardware configuration diagram of a management server according to an embodiment of the present disclosure.

FIG. 8 is a flowchart for explaining a method for automatic collision and overload detection and recovery of a collaborative robot according to an embodiment of the present disclosure.

FIG. 9 is a flowchart for explaining a method for automatic collision detection and work resumption of a collaborative robot using user interface interworking according to an embodiment of the present disclosure.

FIG. 10 is a flowchart for explaining a method for operation and management of a collaborative robot, to which a user-customized graphical interface based on a digital twin is applied, according to an embodiment of the present disclosure.

### DETAILED DESCRIPTION

It should be noted that technical terms used in the present specification are used only for describing particular embodiments and are not intended to limit the present disclosure. In addition, unless the technical terms used in the present specification are specifically defined otherwise in the present specification, the technical terms should be construed as having meanings generally understood by those skilled in the art to which the present disclosure pertains, and should not be construed as having excessively broad meanings or excessively narrow meanings. Further, when a technical term used in the present specification is an incorrect technical term that does not accurately express the spirit of the present disclosure, the technical term should be understood as being replaced by a technical term that can be properly understood by those skilled in the art. In addition, general terms used in the present disclosure should be construed according to dictionary definitions or according to the context before and after, and should not be construed as having excessively narrow meanings.

In addition, singular expressions used in the present specification include plural expressions unless the context clearly indicates otherwise. In the present application, terms such as “configured to” or “have” should not be construed as necessarily including all of various components or various steps described in the specification, and some of the components or some of the steps may not be included, or additional components or steps may be further included.

In addition, terms including ordinals such as first and second used in the present specification may be used to describe various components, but the components should not be limited by the terms. The terms are used only for the purpose of distinguishing one component from another component. For example, a first component may be referred to as a second component without departing from the scope of the present disclosure, and similarly, a second component may also be referred to as a first component.

When a component is described as being “connected” or “coupled” to another component, it should be understood that the component may be directly connected or coupled to the other component, but that another component may also be interposed therebetween. On the other hand, when a component is described as being “directly connected” or “directly coupled” to another component, it should be understood that no other component is interposed therebetween.

Hereinafter, preferred embodiments according to the present disclosure will be described in detail with reference to the accompanying drawings. Regardless of reference numerals, the same or similar components are assigned the same reference numerals, and repeated descriptions thereof will be omitted. In addition, in describing the present disclosure, when it is determined that detailed descriptions of related known technologies may unnecessarily obscure the gist of the present disclosure, the detailed descriptions thereof will be omitted. It should also be noted that the accompanying drawings are provided only to facilitate understanding of the spirit of the present disclosure and should not be construed as limiting the spirit of the present disclosure by the accompanying drawings. The spirit of the present disclosure should be construed as extending to all modifications, equivalents, and substitutes in addition to the accompanying drawings.

Meanwhile, as described above, in order to implement collaborative work between a human and a robot using a collaborative robot, three characteristic factors, namely safety, coexistence, and collaboration, should be satisfied. In particular, safety refers to an ability to avoid a collision with a worker or to detect a collision and avoid a risk resulting from the collision in an unavoidable collision.

Recently, in order to secure safety in implementing collaborative work between a collaborative robot and a human, it has been prescribed that a fence or a sensitive protective device be installed in a work area. However, such measures alone have been insufficient to secure worker safety.

In order to overcome such limitations, the present disclosure proposes various means capable of managing safety with respect to a collision between a collaborative robot and a worker.

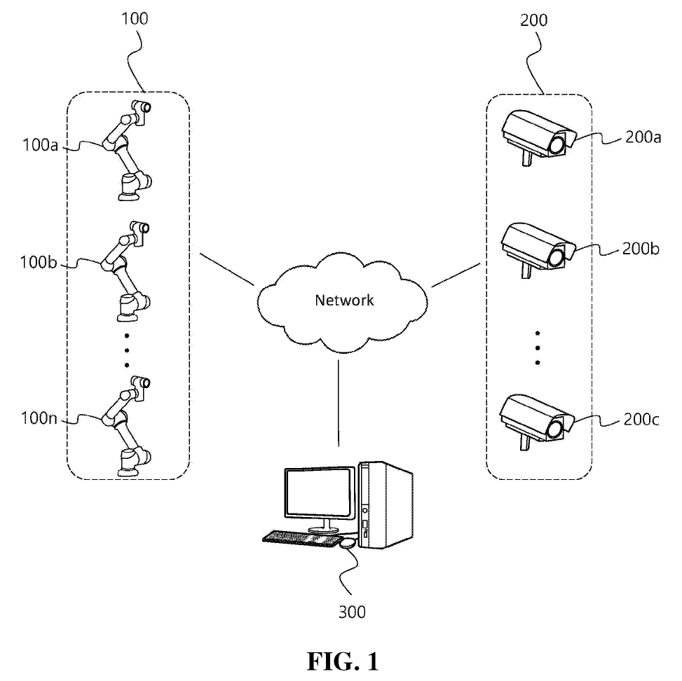

FIG. 1 is a configuration diagram of a safety management system according to an embodiment of the present disclosure.

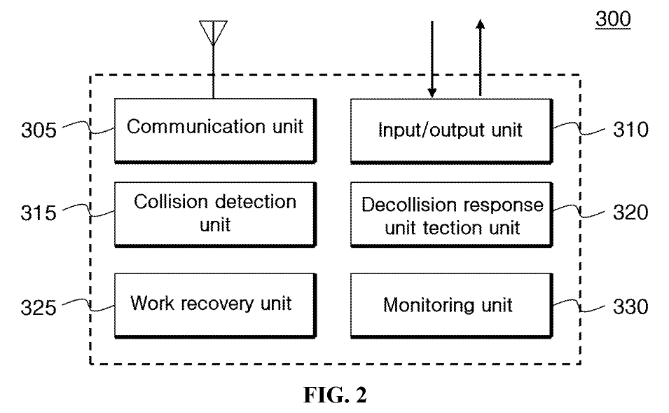

Referring to FIGS. 1 and 2, a safety management system according to an embodiment of the present disclosure may include at least one collaborative robot (100a, 100b, ..., 100n; 100), at least one camera (200a, 200b, ..., 200n; 200), and a management server 300.

The components of the safety management system according to an embodiment of the present disclosure as described above merely represent functionally distinguished components, and thus two or more components may be implemented in an integrated manner in an actual physical environment, or one component may be implemented in a separated manner in an actual physical environment.

Describing each configuration, the collaborative robot 100 may be a device capable of performing transfer, stacking, sorting, and the like of goods in cooperation with a worker in an industrial field.

For example, the collaborative robot 100 may be a device for gripping a good and moving a position of the good. In the following description, the collaborative robot 100 is described as a device for performing palletizing or depalletizing, but is not limited thereto, and various collaborative robots capable of performing cooperation with a worker in an industrial field may be applied.

Specifically, the collaborative robot 100 may be a device capable of gripping a good and stacking the good on a pallet or discharging a good stacked on a pallet. For example, the collaborative robot 100 may include a robot arm, a gripping unit, and a driving unit.

The robot arm may include a plurality of links, at least one joint connecting the plurality of links, and a gripper bracket coupled to an end portion of an end link among the plurality of links. The gripping unit may be installed at an end portion of the robot arm to grip a good or release a gripped good to put down the good. In an embodiment of the present disclosure, the gripping unit may be a vacuum gripper capable of gripping a standardized box-shaped good. However, the present disclosure is not limited thereto, and the gripping unit may employ various types of grippers such as a finger gripper, a soft gripper, and a gecko gripper. The driving unit may independently drive each joint of the robot arm. For example, the driving unit may include a motor, a gear reducer, an encoder, a control circuit, a brake unit, and the like.

As a next configuration, the camera 200 may be installed at various locations in an industrial field to acquire a video of the collaborative robot 100 or a worker. In addition, the camera 200 may acquire a video of the industrial field and transmit the video to the management server 300 in real time. Here, the camera 200 may be a closed-circuit television (CCTV) used for security, surveillance, and the like in the industrial field.

The video acquired from the camera 200 may be used for analyzing a shape of a good to be handled by the collaborative robot 100, a movement of the collaborative robot 100, a movement of a worker, and the like. In addition, the video acquired from the camera 200 may be used for analyzing a shape of the worker and monitoring whether safety equipment is worn and a state of the worker.

For example, the camera 200 may include at least one combination of a vision camera and a thermal camera.

As a next configuration, the management server 300 may integrally control movements of the collaborative robot 100 used in the industrial field. In addition, the management server 300 may monitor states of workers who work in cooperation with the collaborative robot 100 in the industrial field. Such a management server 300 may also be referred to as a remote control system (RCS).

Specifically, the management server 300 may determine whether a collision has occurred based on a torque load applied to the collaborative robot 100, and may control the collaborative robot 100 according to the determined collision occurrence.

In addition, the management server 300 may control the collaborative robot 100 according to a collision, may receive a recovery command related to recovery of the collaborative robot 100, and may recover the collaborative robot 100 according to the received recovery command.

In addition, the management server 300 may collect status information related to operation of the collaborative robot 100, generate a virtual collaborative robot corresponding to the collaborative robot 100 based on the collected status information, and monitor the collaborative robot 100 based on the generated virtual collaborative robot.

The management server 300 is not limited by the term “server,” and any device capable of transmitting and receiving data to and from the collaborative robot 100 and the camera 200 and performing computation based on the transmitted and received data may be employed.

For example, the management server 300 may be any one of fixed computing devices such as a desktop and a workstation, but is not limited thereto.

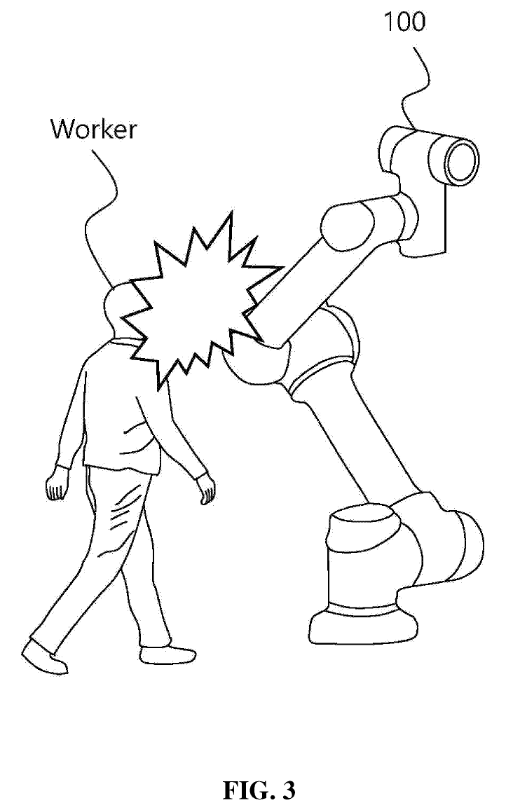

Detailed configurations and operations of the management server 300 will be described later with reference to FIGS. 3 to 8.

As described above, the collaborative robot 100, the camera 200, and the management server 300 may transmit and receive data using a network in which one or more of a dedicated security line directly connecting the devices, a public wired communication network, and a mobile communication network are combined.

For example, the public wired communication network may include Ethernet, x Digital Subscriber Line (xDSL), Hybrid Fiber Coax (HFC), and Fiber To The Home (FTTH), but is not limited thereto. In addition, the mobile communication network may include Code Division Multiple Access (CDMA), Wideband CDMA (WCDMA), High Speed Packet Access (HSPA), Long Term Evolution (LTE), and 5th/6th generation mobile telecommunication, but is not limited thereto.

Hereinafter, a configuration of the management server 300 according to an embodiment of the present disclosure will be described in more detail.

FIG. 2 is a logical configuration diagram of a management server according to an embodiment of the present disclosure.

As illustrated in FIG. 2, the management server 300 according to an embodiment of the present disclosure may include a communication unit 305, an input/output unit 310, a collision detection unit 315, a collision response unit 320, a work recovery unit 325, and a monitoring unit 330.

The components of the management server 300 according to an embodiment of the present disclosure as described above merely represent functionally distinguished components, and thus two or more components may be implemented in an integrated manner in an actual physical environment, or one component may be implemented in a separated manner in an actual physical environment.

Specifically, the communication unit 305 may receive status information from the collaborative robot 100. In addition, the communication unit 305 may transmit a control command to the collaborative robot 100. The communication unit 305 may also receive an image captured by the camera 200. Further, the communication unit 305 may receive status information from the collaborative robot 100.

In addition, the communication unit 305 may transmit and receive data to and from a manufacturing execution system (MES), a material control system (MCS), a warehouse management cloud (WMS), and the like through an equipment interface (EIF).

As a next configuration, the input/output unit 310 may receive information or a command from an administrator through a user interface (UI), and may output a computation result to the outside. Specifically, the input/output unit 310 may receive a command related to control of the collaborative robot 100. In addition, the input/output unit 310 may output status information of the collaborative robot 100.

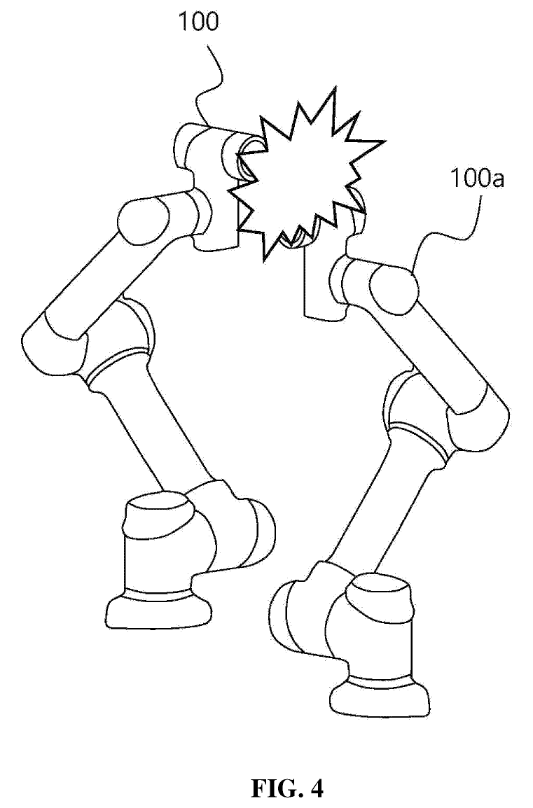

Reference is briefly made to FIGS. 3 and 4 to describe the collision detection unit 315 according to an embodiment of the present disclosure in more detail.

FIGS. 3 and 4 are exemplary diagrams for explaining a collision of a collaborative robot according to an embodiment of the present disclosure.

Referring to FIGS. 3 and 4, the collision detection unit 315 may detect a collision of the collaborative robot 100. For example, as illustrated in FIG. 3, the collision detection unit 315 may detect a collision between the collaborative robot 100 and a worker. Alternatively, the collision detection unit 315 may detect a collision between the collaborative robot 100 and another collaborative robot 100a.

Specifically, the collision detection unit 315 may determine whether a collision has occurred based on a torque load applied to the collaborative robot 100.

In one embodiment, the collision detection unit 315 may receive a current value generated in one or more driving units for rotating or moving a plurality of joints included in the collaborative robot 100. Subsequently, the collision detection unit 315 may estimate a torque load applied to the corresponding driving unit based on the current value.

That is, when the collaborative robot 100 is in a normal operating state, current values generated in the driving units for rotating or moving the plurality of joints of the collaborative robot 100 may be constant. In other words, in the normal operating state, because the driving units operate the plurality of joints with a constant torque, torque loads generated in the driving units may be constant. Here, the torque load generated in each driving unit may be proportional to the current value. Accordingly, the collision detection unit 315 may estimate, based on the current values generated in the driving units, that the torque loads generated in the driving units are constant.

In contrast, when a collision occurs, a torque load applied to the driving unit may change due to the collision. Accordingly, the collision detection unit 315 may distinguish whether a collision has occurred through the torque load of the driving unit.

In another embodiment, the collision detection unit 315 may receive a torque load applied to each joint, the torque load being measured by a torque sensor installed at each joint of the collaborative robot 100. That is, the collision detection unit 315 may receive the torque load from a torque sensor that directly measures a torque actually applied to each joint.

The collision detection unit 315 may determine that the collaborative robot 100 has collided when a torque load of at least one joint among a plurality of joints included in the collaborative robot 100 exceeds a preset value.

As a next configuration, the collision response unit 320 may control the collaborative robot 100 according to the determined collision occurrence.

Specifically, when it is determined that the collaborative robot 100 has collided, the collision response unit 320 may stop operation of the collaborative robot 100. For example, when a torque exceeding a threshold is continuously detected for a predetermined time or longer in a particular joint, the collision response unit 320 may regard the condition as a collision and transmit a control command to the collaborative robot 100.

In one embodiment, when it is determined that the collaborative robot 100 has collided, the collision response unit 320 may identify, among a plurality of joints included in the collaborative robot 100, a joint affected by the collision, and may move the identified joint by a preset distance in a direction opposite to a direction of movement at a time of the collision. For example, when a torque sharply increases in a second joint among a first joint, the second joint, and a third joint included in the collaborative robot for a predetermined time, the collision response unit 320 may determine that the second joint is the joint affected by the collision.

Subsequently, the collision response unit 320 may transmit, to the collaborative robot 100, a control command for moving the identified joint by a preset distance in a direction opposite to the direction of movement at the time of the collision. Through this, the collision response unit 320 may relieve stress on the joint due to the collision, secure a safety distance from a collided object, and perform initial position adjustment for a subsequent recovery operation. Here, the movement distance and the movement speed may be set according to predefined safety criteria. At this time, the collision response unit 320 may identify, as the joint affected by the collision, a joint having a greatest torque load among the plurality of joints.

In another embodiment, when it is determined that the collaborative robot 100 has collided, the collision response unit 320 may move each of the plurality of joints included in the collaborative robot 100 by a preset distance in a direction opposite to a direction of movement at a time of the collision.

Specifically, the collision response unit 320 may identify a direction of movement of each joint at a time when the collision occurs. Here, the direction of movement may be determined based on a velocity vector of each joint as a rotational direction or a linear movement direction of the joint. When the collision is detected, the collision response unit 320 may calculate, for each of the plurality of joints, a direction opposite to the direction of movement at the time of the collision and generate a control command for moving each joint by a preset distance in the opposite direction. Here, the movement distance and the movement speed may be set according to predefined safety criteria. Through this, the collision response unit 320 may allow the collaborative robot 100 to be physically separated from an object collided therewith immediately after the collision occurs, thereby preventing secondary contact or equipment damage and supporting the robot system to be rapidly transitioned into a stable state. In addition, even when it is difficult to clearly identify a particular joint affected by the collision, the collision response unit 320 may enable a rapid response to a collision situation by collectively controlling all of the joints.

In addition, when it is determined that the collaborative robot 100 has collided, the collision response unit 320 may cumulatively store torque loads generated in each of the plurality of joints included in the collaborative robot 100, and may predict a maintenance timing for each of the plurality of joints based on the cumulatively stored torque loads.

Specifically, whenever a collision occurs, the collision response unit 320 may record, together with time information, a torque load value measured for each joint at the time of the collision, thereby building a joint-specific history database. Here, the cumulatively stored torque load data may be used as an important indicator reflecting fatigue, wear, and potential defect possibility of each joint. For example, when an excessive torque load repeatedly occurs in the same joint, a maintenance timing of the corresponding joint may be shortened as compared with other joints.

Accordingly, the collision response unit 320 may predict, based on the accumulated torque load data, a timing at which maintenance is required or an expected failure timing for each joint by applying predefined maintenance criteria. At this time, when a sum of torque loads cumulatively stored for each of the plurality of joints exceeds a preset value, the collision response unit 320 may predict that a maintenance timing for the corresponding joint has arrived.

In addition, the collision response unit 320 may identify a type of collision object based on a magnitude of the torque load applied to the collaborative robot 100, and may differently control operation of the collaborative robot 100 according to the identified type of collision object.

Specifically, when a collision occurs, the collision response unit 320 may analyze a magnitude of a torque load generated due to the collision and identify a type of an object that has collided. For example, when torque sharply increases upon a collision and then rapidly disappears within a short time, the collision response unit 320 may determine that the collaborative robot has collided with a worker, and when torque equal to or greater than a preset value continues, the collision response unit 320 may determine that the collaborative robot has collided with another collaborative robot.

Subsequently, when the identified collision object is another collaborative robot, the collision response unit 320 may attempt communication based on an identifier of the other collaborative robot and may receive current status information from the other collaborative robot. The status information may include whether the other collaborative robot is operating, whether an error has occurred, whether the other collaborative robot is in a standby state, and the like.

Further, when it is confirmed that the collision is a simple contact and that the other collaborative robot is in a normal state by analyzing the received status information of the other collaborative robot, the collision response unit 320 may control the collaborative robot 100 to automatically resume operation under a predetermined condition. Through this, the collision response unit 320 may minimize unnecessary stops due to a collision in a collaborative work environment among collaborative robots and may secure both continuity and stability of work.

As a next configuration, the work recovery unit 325 may detect a collision of the collaborative robot 100 and may efficiently resume operation of the collaborative robot 100 through a graphical user interface (GUI).

To this end, the work recovery unit 325 may control the collaborative robot 100 according to a collision. For example, when it is detected that the collaborative robot 100 has collided, the work recovery unit 325 may stop operation of the collaborative robot 100. However, the present disclosure is not limited thereto, and the work recovery unit 325 may control the collaborative robot 100 according to a collision in various ways as described above.

Subsequently, the work recovery unit 325 may receive a recovery command related to recovery of the collaborative robot 100.

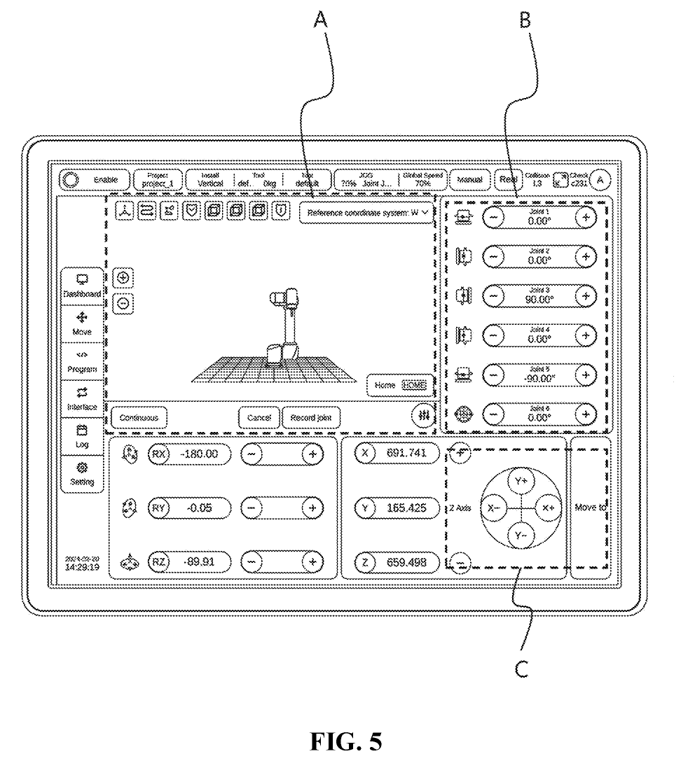

Reference is briefly made to FIG. 5 to describe a graphical user interface (GUI) according to an embodiment of the present disclosure in more detail.

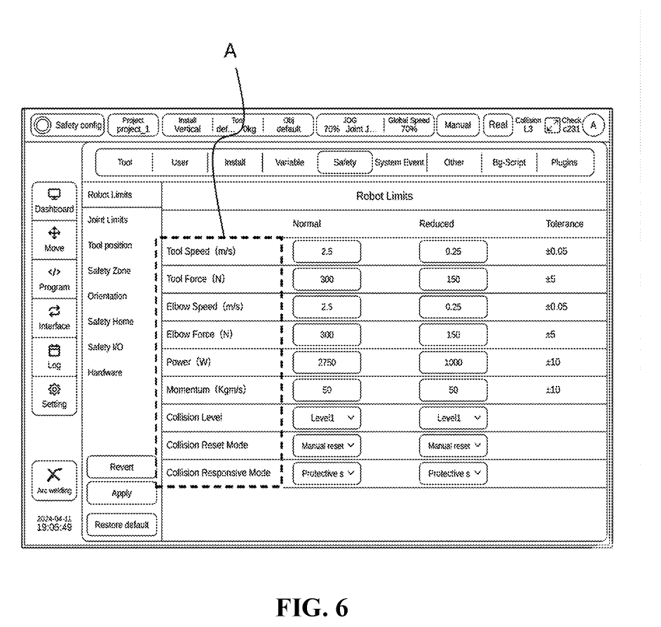

FIGS. 5 and 6 are exemplary diagrams for explaining a graphical user interface (GUI) according to an embodiment of the present disclosure.

Referring to FIG. 5, the work recovery unit 325 may output a plurality of icons for controlling the collaborative robot through a graphical user interface (GUI).

Specifically, the work recovery unit 325 may implement a graphical user interface (GUI) through the input/output unit 310, and, after a collision is detected, the collaborative robot 100 may be transitioned into a stopped state, and a plurality of icons for visually expressing various control options related to recovery may be output on a screen. For example, the work recovery unit 325 may output a virtual collaborative robot (A) representing a current operation state of the collaborative robot 100, an icon (B) for changing an angle of each joint of the collaborative robot 100 through the virtual collaborative robot (A), and an icon (C) for changing a view point of the virtual collaborative robot (A).

In addition, the work recovery unit 325 may receive status information of the collaborative robot 100 and may output, to an administrator, at least one recommended recovery command based on the status information.

Specifically, after a collision is detected, the work recovery unit 325 may receive, in real time from the collaborative robot 100, status information such as a joint position, a torque load, a speed, and a collision detection time. Based on the status information, the work recovery unit 325 may select at least one of a plurality of recovery commands suitable for a corresponding situation as a recommended command through a predefined recovery-command scenario database. For example, when a collision is minor and a position error at the time of the collision is small, the work recovery unit 325 may output a recovery command such as “automatic position return and restart.” Alternatively, when a torque load of a particular joint exceeds a threshold at the time of the collision, the work recovery unit 325 may output a recovery command such as “enter manual inspection mode after separating the collided joint.” When repeated collisions are detected multiple times, the work recovery unit 325 may output a recovery command such as “stop all operations and wait for administrator approval.”

The work recovery unit 325 may express such recommended recovery commands in text and graphics on a graphical user interface (GUI) screen. Here, the administrator may recover the collaborative robot by selecting an output recommended recovery command.

In addition, the work recovery unit 325 may identify a collision type based on a collision occurrence position, an occurrence time, a torque load, and posture information at the time of the collision of the collaborative robot 100, and may extract and output one of prestored recovery scenarios corresponding to the identified collision type.

Specifically, when a collision is detected in the collaborative robot 100, the work recovery unit 325 may receive a collision occurrence position, an occurrence time, a torque load at a time of the collision, and posture information of the robot at that time, and may identify a collision type by comprehensively analyzing the received information. Here, the collision type may be determined based on a collision site, a magnitude and duration of torque, and whether posture stability is secured at the time of the collision. For example, the collision type may be classified into contact with a person, collision with a fixed structure, contact with another collaborative robot, and the like.

The work recovery unit 325 may extract, from a prestored recovery-scenario database, a recovery scenario corresponding to the corresponding type and may output the extracted recovery scenario through a user interface. Here, the recovery scenario may include maintaining an automatic stop, inducing manual inspection, joint return, path bypass, automatic resumption, and the like according to a collision situation.

In this manner, the work recovery unit 325 may automatically suggest a recovery procedure suitable for a situation based on accurate analysis of a collision situation, thereby reducing a response burden on the administrator and improving recovery speed and work-resumption efficiency of the robot.

In addition, when a particular recovery scenario is selected by the administrator, the work recovery unit 325 may output a simulation image simulating an operation process of the collaborative robot 100 so that contents of the corresponding recovery scenario can be visually confirmed. Here, the simulation image may be configured as a virtual three-dimensional model according to a recovery procedure of the actual collaborative robot 100 and may allow a movement position and an operation of each joint of the collaborative robot 100 during the recovery process to be visually confirmed. Through this, the administrator may confirm in advance whether the recovery procedure is appropriate through the simulation image, may predict whether interference with another collaborative robot or a worker in a work space will occur, and may determine whether a recovery operation can be performed within a safe range.

Further, in outputting the simulation image for the recovery scenario, the work recovery unit 325 may identify a collision target object based on an actual image of the collaborative robot 100 captured at the time of the collision and may generate the identified object in the simulation image so that the object is simulated together.

Specifically, the work recovery unit 325 may automatically identify, through an image-recognition algorithm, an object directly contacting the collaborative robot in an image or an object causing the collision. For example, the collision target object may be a worker, another collaborative robot, process equipment, a fixed structure, or the like. Further, the work recovery unit 325 may implement the identified object together in the simulation image of the recovery scenario. Through this, the administrator may visually confirm how the collaborative robot will perform an operation in consideration of the corresponding object. In addition, the administrator may increase confidence before executing the recovery command and may review in advance a secondary collision or a risk factor that may occur in a recovery process.

Subsequently, the work recovery unit 325 may recover the collaborative robot 100 according to the received recovery command.

In one embodiment, the work recovery unit 325 may control the collaborative robot 100 to return to an initial posture after the collision. Here, the initial posture may mean a safe posture designed such that each joint of the collaborative robot 100 is positioned at a stable position, the safe posture being a reference posture set before occurrence of the collision or at a time when work starts.

In another embodiment, the work recovery unit 325 may control the collaborative robot 100 to automatically resume an interrupted operation. Here, the work recovery unit 325 may refer to an operation history until immediately before the collision occurs, identify a process or work routine interrupted at the time of the collision, move the collaborative robot 100 to an interruption point of the corresponding operation or a nearest resumption point, and then re-execute a work flow.

At this time, in recovering the collaborative robot 100 according to the recovery command, the work recovery unit 325 may limit a safety parameter of the collaborative robot 100 in order to prevent a secondary accident or malfunction that may occur during operation of the collaborative robot 100. The safety parameter may mean a constraint condition such as an operation range, a speed, or a torque applied during a recovery operation of the collaborative robot 100.

Specifically, as illustrated in FIG. 6(A), the work recovery unit 325 may limit at least one of a maximum end speed of the collaborative robot, a maximum force externally applied at an end of the collaborative robot, a maximum elbow speed of the collaborative robot, and a maximum elbow force applied to a joint of the collaborative robot.

Here, the maximum end speed of the collaborative robot may mean a highest speed at which an end effector of the robot can move during a recovery operation, and by setting the maximum end speed to be low, an unexpected abrupt movement during the recovery may be prevented. The maximum force externally applied at the end of the collaborative robot may designate an allowable maximum reaction-force range when the collaborative robot comes into contact with an external object or a worker, and by limiting the value, a risk of injury upon collision may be minimized. The maximum elbow speed of the collaborative robot may designate a maximum speed at which each joint can rotate or move, and may allow movement of each joint to be controlled more gently during the recovery. The maximum elbow force applied to each joint of the collaborative robot may mean a limit value of a maximum force that can be output by a joint driving unit, and by limiting the value, a mechanical overload or structural damage may be prevented.

In addition, the work recovery unit 325 may limit at least one of minimum and maximum positions of each joint of the collaborative robot 100, a maximum angular velocity of each joint, and a maximum torque of each joint. Through this, the work recovery unit 325 may ensure that a recovery operation does not exceed a physical limit of the collaborative robot 100.

As a next configuration, the monitoring unit 330 may monitor a state of the collaborative robot in real time through a digital twin and may efficiently control and manage the collaborative robot.

To this end, the monitoring unit 330 may collect status information related to operation of the collaborative robot 100.

Specifically, in order to generate a virtual collaborative robot based on an operation state and surrounding environment information of the collaborative robot 100 and to monitor the collaborative robot 100 in real time through the generated virtual collaborative robot, the monitoring unit 330 may collect various types of status information of the collaborative robot 100.

That is, the monitoring unit 330 may receive image data obtained by capturing the collaborative robot 100 with a camera, and at the same time may collect point cloud data acquired using LiDAR, thereby accurately identifying an actual shape, a position, and a spatial arrangement of the collaborative robot 100.

In addition, the monitoring unit 330 may collect internal status information collected through various sensors included in the collaborative robot 100. For example, the monitoring unit 330 may collect status information such as a position, a movement speed, a driving torque, an acceleration, and an operating temperature of each joint or an end effector. Through this, the monitoring unit 330 may determine an operation state of the robot such as an operating load, an abnormal sign, and whether overheating has occurred.

At this time, the monitoring unit 330 may additionally collect surrounding-object information of the collaborative robot 100 based on at least one of an image of an industrial field in which the collaborative robot 100 exists, the image being captured by a camera, and point cloud data acquired by LiDAR simultaneously with the image. For example, the surrounding object may be another collaborative robot, a worker, a fixed structure, or the like.

Subsequently, the monitoring unit 330 may generate a virtual collaborative robot corresponding to the collaborative robot 100 based on the collected status information. That is, as illustrated in FIG. 5, the monitoring unit 330 may generate, based on the collected status information, a virtual collaborative robot (A) having the same physical characteristics as the collaborative robot 100 and may synchronize an operation state of the actual collaborative robot 100 with the generated virtual collaborative robot in real time.

Specifically, the monitoring unit 330 may analyze collected information such as a position, a joint angle, a speed, a torque, an acceleration, and a temperature of the collaborative robot 100, and may generate, in a three-dimensional virtual space, a virtual collaborative robot having the same physical structure and motion characteristics as the actual collaborative robot 100, including a size, a joint configuration, a driving range, a connection relationship among joints, and operation characteristics. Here, the generated virtual collaborative robot may periodically update its operation state by reflecting status information updated in real time. For example, when a particular joint of the actual collaborative robot rotates or its speed changes, a corresponding joint of the virtual collaborative robot may move in the same manner, and an abnormal movement or a stopped state at the time of a collision may also be reflected in real time.

In addition, based on the status information of the collaborative robot 100 and the collected surrounding-object information, the monitoring unit 330 may generate a virtual surrounding object for reproducing an environment in which the collaborative robot 100 is located, and may also synchronize a state of the virtual surrounding object in real time.

Specifically, the monitoring unit 330 may analyze position and shape data of fixed structures, work tables, machine equipment, moving equipment, workers, and the like in an industrial field through an image acquired by a camera and point cloud data collected through LiDAR, and may generate corresponding three-dimensional objects in a virtual space based on the analyzed data. Here, the generated virtual surrounding objects may reflect physical characteristics such as a position, a size, and whether movement occurs, in the same manner as in reality. For example, when a worker passes near the collaborative robot, a corresponding human-body model may move in the virtual environment, and a distance to the robot or an interaction with the robot may be visually represented.

Subsequently, the monitoring unit 330 may monitor the collaborative robot 100 based on the generated virtual collaborative robot.

To this end, the monitoring unit 330 may output the generated virtual collaborative robot through a graphical user interface (GUI).

Specifically, the monitoring unit 330 may visualize, in a two-dimensional or three-dimensional graphic form, the virtual collaborative robot and the surrounding objects generated in the virtual space based on the digital twin. Through this, an administrator may intuitively check a current operation state and a work environment of the collaborative robot 100.

In particular, the monitoring unit 330 may store collected status information and operation information of the virtual collaborative robot by assigning timestamps thereto. That is, the monitoring unit 330 may store, at predetermined time intervals, status information such as a position, a speed, a torque, a posture, and a position of a surrounding object, which are periodically received from the collaborative robot 100, and operation data of the virtual collaborative robot generated based on the status information, and may assign a unique timestamp to each storage time point.

Further, when a specific time period of the timestamps is selected, the monitoring unit 330 may output an operation of the virtual collaborative robot corresponding to the selected time period through a graphical user interface (GUI). That is, when an administrator selects a desired time period through a time-selection interface provided on the GUI, the monitoring unit 330 may load a state and operation information of the virtual collaborative robot corresponding to the selected time period and may output the loaded information on the GUI.

For example, when the administrator selects a time point at which a collision is estimated to have occurred, an operation performed by the virtual collaborative robot at the corresponding time point may be reproduced as it is, and a joint movement of the collaborative robot, an end-effector position, and an interaction state with a surrounding object may be visually checked.

Further, when outputting an operation of the virtual collaborative robot corresponding to the selected time period based on the timestamps, the monitoring unit 330 may additionally provide an editing interface so that the administrator can modify or supplement the corresponding operation. Here, the editing interface may be implemented in a GUI environment and may include various manipulation tools enabling the administrator to select and adjust a position of each joint, a path of an end effector, a speed, a posture, and the like of the virtual collaborative robot. For example, the administrator may move a robot-arm position at a particular time period in a drag-and-drop manner, adjust a joint rotation angle, delete an unnecessary movement, or insert a new operation.

In addition, the monitoring unit 330 may output, again in the form of a simulation, an operation of the virtual collaborative robot edited through the editing interface so that the administrator can confirm the edited operation. That is, the monitoring unit 330 may regenerate a new operation to be performed by the virtual collaborative robot based on the edited operation information and may visually simulate the regenerated operation on the GUI.

Further, when a selection signal is input by the administrator, the monitoring unit 330 may convert operation information of the virtual collaborative robot edited through the editing interface into a test control command applicable to the collaborative robot 100.

At this time, in order to process operation information of the virtual collaborative robot, generated or modified through the editing interface, so as to be applicable to the actual collaborative robot 100, the monitoring unit 330 may convert the operation information of the virtual collaborative robot into joint values of the collaborative robot 100 based on an inverse kinematics algorithm.

Specifically, the edited operation information of the virtual collaborative robot may generally be represented as a position and an orientation of an end effector in a three-dimensional space. Such operation information is suitable for intuitively defining a work path of the collaborative robot 100, but, in order to actually drive the collaborative robot 100, conversion into values in a joint space, such as a rotation angle or a movement amount for each joint, is required. Accordingly, the monitoring unit 330 may calculate, using the operation path of the virtual collaborative robot as an input, an angle value for each joint to achieve the corresponding end-effector position and orientation. Through this, the monitoring unit 330 may generate an optimal control command in consideration of a kinematic structure of the collaborative robot 100, a connection relationship among joints, kinematic constraints, and physical limit values.

Hereinafter, hardware for implementing the logical components of the management server 300 as described above will be described in more detail.

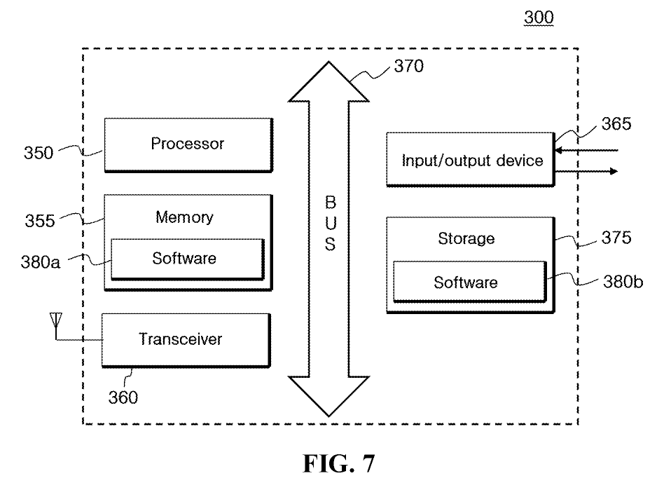

FIG. 7 is a hardware configuration diagram of a management server according to an embodiment of the present disclosure.

As illustrated in FIG. 7, the management server 300 may include a processor 350, a memory 355, a transceiver 360, an input/output device 365, a data bus 370, and a storage 375.

Specifically, based on instructions according to software 380a implementing a method for automatic collision and overload detection and recovery of a collaborative robot, a method for automatic collision detection and work resumption of a collaborative robot using user interface interworking, and a method for operation and management of a collaborative robot to which a user-customized graphical interface based on a digital twin is applied, the software 380a being resident in the memory 355, the processor 350 may implement operations and functions of the management server 300.

. Software 380b implementing a method for automatic collision and overload detection and recovery of a collaborative robot, a method for automatic collision detection and work resumption of a collaborative robot using user interface interworking, and a method for operation and management of a collaborative robot to which a user-customized graphical interface based on a digital twin is applied, the software 380b being stored in the storage 375, may be loaded into the memory 355.

The input/output device 365 may receive a signal required for operation of the management server 300 or may output a computation result to the outside according to a command of the processor 350.

The data bus 370 may be connected to the processor 350, the memory 355, the transceiver 360, the input/output device 365, and the storage 375, respectively, and may serve as a transfer path for transmitting signals among the respective components.

The storage 375 may store an application programming interface (API), a library file, a resource file, and the like required for execution of software 380a implementing a method for automatic collision and overload detection and recovery of a collaborative robot, a method for automatic collision detection and work resumption of a collaborative robot using user interface interworking, and a method for operation and management of a collaborative robot to which a user-customized graphical interface based on a digital twin is applied, according to embodiments of the present disclosure. The storage 375 may store software 380b implementing the method for automatic collision and overload detection and recovery of a collaborative robot, the method for automatic collision detection and work resumption of a collaborative robot using user interface interworking, and the method for operation and management of a collaborative robot to which a user-customized graphical interface based on a digital twin is applied, according to embodiments of the present disclosure.

According to an embodiment of the present disclosure, software 380a and 380b for implementing the method for automatic collision and overload detection and recovery of a collaborative robot, the software 380a and 380b being resident in the memory 355 or stored in the storage 375, may be a computer program recorded on a recording medium for causing the processor 350 to execute determining whether a collision has occurred based on a torque load applied to the collaborative robot and controlling the collaborative robot according to the determined collision occurrence.

According to another embodiment of the present disclosure, software 380a and 380b for implementing the method for automatic collision detection and work resumption of a collaborative robot using user interface interworking, the software 380a and 380b being resident in the memory 355 or stored in the storage 375, may be a computer program recorded on a recording medium for causing the processor 350 to execute controlling the collaborative robot according to a collision, receiving a recovery command related to recovery of the collaborative robot, and recovering the collaborative robot according to the recovery command.

According to still another embodiment of the present disclosure, software 380a and 380b for implementing the method for operation and management of a collaborative robot to which a user-customized graphical interface based on a digital twin is applied, the software 380a and 380b being resident in the memory 355 or stored in the storage 375, may be a computer program recorded on a recording medium for causing the processor 350 to execute collecting status information related to operation of the collaborative robot, generating a virtual collaborative robot corresponding to the collaborative robot based on the collected status information, and monitoring the generated virtual collaborative robot.

More specifically, the processor 350 may include one or more of a central processing unit (CPU), an application-specific integrated circuit (ASIC), a chipset, and a logic circuit, but is not limited thereto.

The memory 355 may include one or more of a ROM (Read-Only Memory), a RAM (Random Access Memory), a flash memory, and a memory card, but is not limited thereto.

The input/output device 365 may include one or more of input devices such as a button, a switch, a keyboard, a mouse, and a joystick, and output devices such as an LCD (Liquid Crystal Display), an LED (Light Emitting Diode), an organic LED (Organic LED, OLED), an active matrix OLED (AMOLED), a printer, and a plotter, but is not limited thereto.

When an embodiment included in the present specification is implemented in software, the above-described methods may be implemented as modules (processes, functions, and the like) respectively performing the above-described functions. Each module may be resident in the memory 355 and may be executed by the processor 350. The memory 355 may exist inside or outside the processor 350 and may be connected to the processor 350 by various well-known means.

Each component illustrated in FIG. 7 may be implemented by various means (for example, hardware, firmware, software, or a combination thereof). When implemented by hardware, an embodiment of the present disclosure may be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, microcontrollers, microprocessors, and the like.

In addition, when implemented by firmware or software, an embodiment of the present disclosure may be implemented in the form of modules, procedures, functions, and the like for performing the functions or operations described above, and may be recorded on a recording medium readable through various computer means. Here, the recording medium may include program instructions, data files, data structures, and the like alone or in combination.

Program instructions recorded on the recording medium may be those specially designed and configured for the present disclosure or may be those known and available to those of ordinary skill in the computer software art. Examples of the recording medium may include magnetic media such as a hard disk, a floppy disk, and a magnetic tape, optical recording media such as a CD-ROM (Compact Disk Read Only Memory) and a DVD (Digital Video Disk), magneto-optical media such as a floptical disk, and hardware devices specially configured to store and execute program instructions, such as a ROM, a RAM, and a flash memory.

Examples of the program instructions may include not only machine language code generated by a compiler but also high-level language code executable by a computer using an interpreter or the like. Such hardware devices may be configured to operate as one or more pieces of software in order to perform operations of the present disclosure, and vice versa.

Hereinafter, a method for automatic collision and overload detection and recovery of a collaborative robot according to an embodiment of the present disclosure will be described.

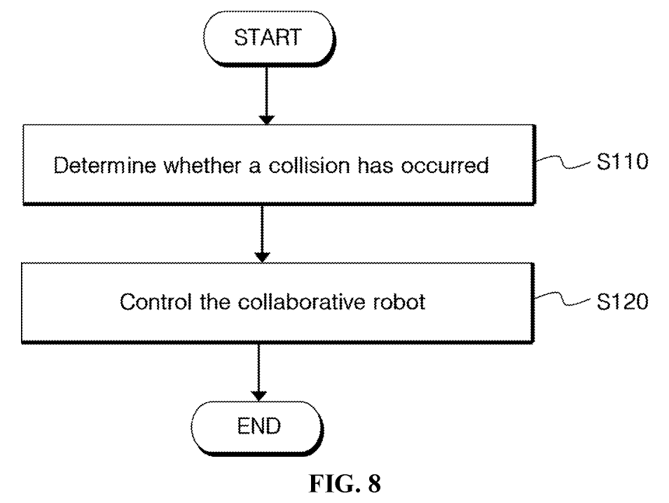

FIG. 8 is a flowchart for explaining a method for automatic collision and overload detection and recovery of a collaborative robot according to an embodiment of the present disclosure.

Referring to FIG. 8, first, in operation S110, the management server may detect a collision of the collaborative robot.

Specifically, the management server may determine whether a collision has occurred based on a torque load applied to the collaborative robot.

In one embodiment, the management server may receive a current value generated in one or more driving units for rotating or moving a plurality of joints included in the collaborative robot. Subsequently, the management server may estimate a torque load applied to the corresponding driving unit based on the current value.

In another embodiment, the management server may receive a torque load applied to each joint, the torque load being measured by a torque sensor installed at each joint of the collaborative robot. That is, the management server may receive the torque load from a torque sensor that directly measures a torque actually applied to each joint.

The management server may determine that the collaborative robot has collided when a torque load of at least one joint among a plurality of joints included in the collaborative robot exceeds a preset value.

Next, in operation S120, the management server may control the collaborative robot according to the collision occurrence determined in operation S110.

Specifically, when it is determined that the collaborative robot has collided, the management server may stop operation of the collaborative robot. For example, when a torque exceeding a threshold is continuously detected for a predetermined time or longer in a particular joint, the management server may regard the condition as a collision and may transmit a control command to the collaborative robot.

In one embodiment, when it is determined that the collaborative robot has collided, the management server may identify, among a plurality of joints included in the collaborative robot, a joint affected by the collision and may move the identified joint by a preset distance in a direction opposite to a direction of movement at the time of the collision.

Subsequently, the management server may transmit, to the collaborative robot, a control command for moving the identified joint by a preset distance in a direction opposite to the direction of movement at the time of the collision. Through this, the management server may relieve stress on the joint due to the collision, secure a safety distance from a collided object, and perform initial position adjustment for a subsequent recovery operation.

In another embodiment, when it is determined that the collaborative robot has collided, the management server may move each of the plurality of joints included in the collaborative robot by a preset distance in a direction opposite to a direction of movement at the time of the collision.

Specifically, the management server may identify a direction of movement of each joint at the time when the collision occurs. Here, the direction of movement may be determined based on a velocity vector of each joint as a rotational direction or a linear movement direction of the joint. When the collision is detected, the management server may calculate, for each of the plurality of joints, a direction opposite to the direction of movement at the time of the collision and may generate a control command for moving each joint by a preset distance in the opposite direction.

In addition, the management server may cumulatively store torque loads generated in each of the plurality of joints included in the collaborative robot when it is determined that the collaborative robot has collided, and may predict a maintenance timing for each of the plurality of joints based on the cumulatively stored torque loads.

Specifically, whenever a collision occurs, the management server may record, together with time information, a torque load value measured for each joint at the time of the collision, thereby building a joint-specific history database. Accordingly, the management server may predict a timing at which maintenance is required or an expected failure timing for each joint by applying predefined maintenance criteria based on the accumulated torque load data. At this time, when a sum of torque loads cumulatively stored for each of the plurality of joints exceeds a preset value, the management server may predict that a maintenance timing for the corresponding joint has arrived.

In addition, the management server may identify a type of collision object based on a magnitude of the torque load applied to the collaborative robot and may differently control operation of the collaborative robot according to the identified type of collision object.

Specifically, when a collision occurs, the management server may analyze a magnitude of a torque load generated due to the collision and may identify a type of an object that has collided. Subsequently, when the identified collision object is another collaborative robot, the management server may attempt communication based on an identifier of the other collaborative robot and may receive current status information from the other collaborative robot.

Further, when it is confirmed that the collision is a simple contact and that the other collaborative robot is in a normal state by analyzing the received status information of the other collaborative robot, the management server may control the collaborative robot so that operation thereof is automatically resumed under a predetermined condition.

Hereinafter, a method for automatic collision detection and work resumption of a collaborative robot using user interface interworking according to an embodiment of the present disclosure will be described.

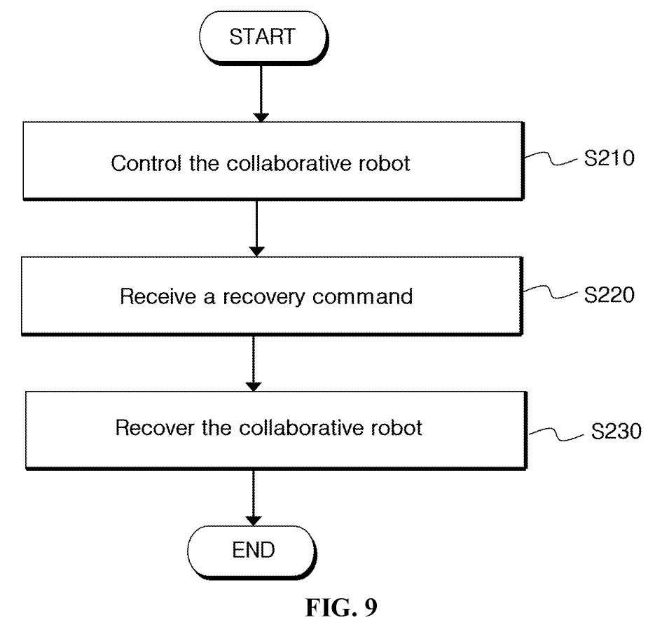

FIG. 9 is a flowchart for explaining a method for automatic collision detection and work resumption of a collaborative robot using user interface interworking according to an embodiment of the present disclosure.

Referring to FIG. 9, in operation S210, the management server may control the collaborative robot according to a collision. For example, when it is detected that the collaborative robot has collided, the management server may stop operation of the collaborative robot 100.

Next, in operation S220, the management server may receive a recovery command related to recovery of the collaborative robot 100.

Specifically, the management server may implement a graphical user interface (GUI), and, after a collision is detected, the collaborative robot may be transitioned into a stopped state, and a plurality of icons for visually expressing various control options related to recovery may be output on a screen.

In addition, the management server may receive status information of the collaborative robot and may output, to an administrator, at least one recommended recovery command based on the status information.

Specifically, after a collision is detected, the management server may receive, in real time from the collaborative robot, status information such as a joint position, a torque load, a speed, and a collision detection time. Based on the status information, the management server may select at least one of a plurality of recovery commands suitable for a corresponding situation as a recommended command through a predefined recovery-command scenario database.

The management server may express such recommended recovery commands in text and graphics on a graphical user interface (GUI) screen. Here, the administrator may recover the collaborative robot by selecting an output recommended recovery command.

In addition, the management server may identify a collision type based on a collision occurrence position, an occurrence time, a torque load, and posture information at the time of the collision of the collaborative robot, and may extract and output one of prestored recovery scenarios corresponding to the identified collision type.

Specifically, when a collision is detected in the collaborative robot, the management server may receive a collision occurrence position, an occurrence time, a torque load at a time of the collision, and posture information of the robot at that time, and may identify a collision type by comprehensively analyzing the received information. Here, the collision type may be determined based on a collision site, a magnitude and duration of torque, and whether posture stability is secured at the time of the collision.

The management server may extract, from a prestored recovery-scenario database, a recovery scenario corresponding to the corresponding type and may output the extracted recovery scenario through a user interface. Here, the recovery scenario may include maintaining an automatic stop, inducing manual inspection, joint return, path bypass, automatic resumption, and the like according to a collision situation.

In addition, when a particular recovery scenario is selected by the administrator, the management server may output a simulation image simulating an operation process of the collaborative robot so that contents of the corresponding recovery scenario can be visually confirmed. Here, the simulation image may be configured as a virtual three-dimensional model according to a recovery procedure of the actual collaborative robot 100 and may allow a movement position and an operation of each joint of the collaborative robot 100 during the recovery process to be visually confirmed.

Further, in outputting the simulation image for the recovery scenario, the management server may identify a collision target object based on an actual image of the collaborative robot captured at the time of the collision and may generate the identified object in the simulation image so that the object is simulated together.

Specifically, the management server may automatically identify, through an image-recognition algorithm, an object directly contacting the collaborative robot in an image or an object causing the collision. For example, the collision target object may be a worker, another collaborative robot, process equipment, a fixed structure, or the like. Further, the management server may implement the identified object together in the simulation image of the recovery scenario.

Further, the management server may recover the collaborative robot according to the received recovery command.

In one embodiment, the management server may control the collaborative robot to return to an initial posture after the collision. Here, the initial posture may mean a safe posture designed such that each joint of the collaborative robot is positioned at a stable position, the safe posture being a reference posture set before occurrence of the collision or at a time when work starts.

In another embodiment, the management server may control the collaborative robot to automatically resume an interrupted operation. Here, the management server may refer to an operation history until immediately before the collision occurs, identify a process or work routine interrupted at the time of the collision, move the collaborative robot to an interruption point of the corresponding operation or a nearest resumption point, and then re-execute a work flow.

At this time, in recovering the collaborative robot according to the recovery command, the management server may limit a safety parameter of the collaborative robot in order to prevent a secondary accident or malfunction that may occur during operation of the collaborative robot.

Specifically, the management server may limit at least one of a maximum end speed of the collaborative robot, a maximum force externally applied at an end of the collaborative robot, a maximum elbow speed of the collaborative robot, and a maximum elbow force applied to a joint of the collaborative robot.

In addition, the management server may limit at least one of minimum and maximum positions of each joint of the collaborative robot, a maximum angular velocity of each joint, and a maximum torque of each joint.

Hereinafter, a method for operation and management of a collaborative robot to which a user-customized graphical interface based on a digital twin is applied according to an embodiment of the present disclosure will be described.

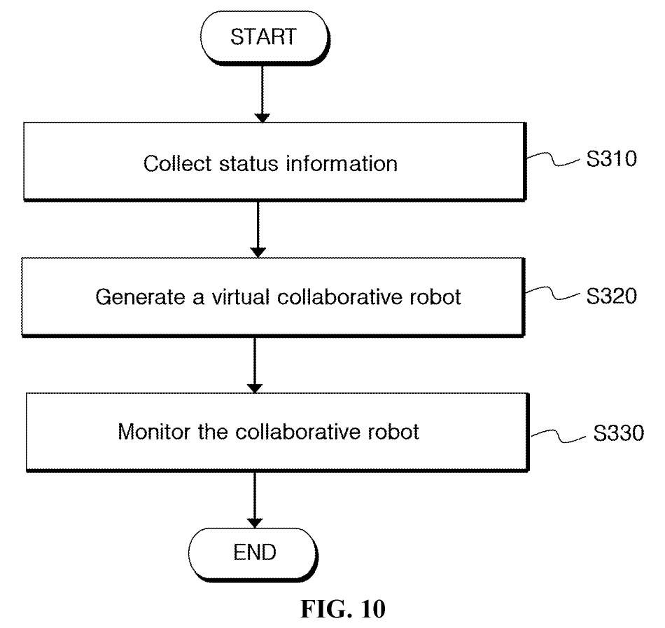

FIG. 10 is a flowchart for explaining a method for operation and management of a collaborative robot to which a user-customized graphical interface based on a digital twin is applied according to an embodiment of the present disclosure.

Referring to FIG. 10, in operation S310, the management server may collect status information related to operation of the collaborative robot.

Specifically, the management server may receive image data obtained by capturing the collaborative robot with a camera, and at the same time may collect point cloud data acquired using LiDAR.

In addition, the management server may collect status information such as a position, a movement speed, a driving torque, an acceleration, and an operating temperature of each joint or an end effector through various sensors included in the collaborative robot.

At this time, the management server may additionally collect surrounding-object information of the collaborative robot based on at least one of an image of an industrial field in which the collaborative robot exists, the image being captured by a camera, and point cloud data acquired by LiDAR simultaneously with the image.

Next, in operation S320, the management server may generate a virtual collaborative robot corresponding to the collaborative robot based on the collected status information.

Specifically, the management server may analyze collected information such as a position, a joint angle, a speed, a torque, an acceleration, and a temperature of the collaborative robot, and may generate, in a three-dimensional virtual space, a virtual collaborative robot having the same physical structure and motion characteristics as the actual collaborative robot, including a size, a joint configuration, a driving range, a connection relationship among joints, and operation characteristics. Here, the generated virtual collaborative robot may periodically update its operation state by reflecting status information updated in real time.

In addition, the management server may generate, based on status information of the collaborative robot and collected surrounding-object information, a virtual surrounding object for reproducing an environment in which the collaborative robot is located, and may synchronize a state of the virtual surrounding object in real time.

Specifically, the management server may analyze position and shape data of fixed structures, work tables, machine equipment, moving equipment, workers, and the like in an industrial field through an image acquired by a camera and point cloud data collected through LiDAR, and may generate corresponding three-dimensional objects in a virtual space based on the analyzed data.

Further, the management server may monitor the collaborative robot based on the generated virtual collaborative robot. To this end, the management server may output the generated virtual collaborative robot through a graphical user interface (GUI).

Specifically, the management server may visualize, in a two-dimensional or three-dimensional graphic form, the virtual collaborative robot and the surrounding objects generated in a virtual space based on a digital twin. Through this, an administrator may intuitively check a current operation state and a work environment of the collaborative robot.

In particular, the management server may store collected status information and operation information of the virtual collaborative robot by assigning timestamps thereto. That is, the management server may store, at predetermined time intervals, status information such as a position, a speed, a torque, a posture, and a position of a surrounding object, which are periodically received from the collaborative robot, and operation data of the virtual collaborative robot generated based on the status information, and may assign a unique timestamp to each storage time point.

Further, when a specific time period of the timestamps is selected, the management server may output an operation of the virtual collaborative robot corresponding to the selected time period through a graphical user interface (GUI). That is, when an administrator selects a desired time period through a time-selection interface provided on the GUI, the management server may load a state and operation information of the virtual collaborative robot corresponding to the selected time period and may output the loaded information on the GUI.

Further, when outputting an operation of the virtual collaborative robot corresponding to the selected time period based on the timestamps, the management server may additionally provide an editing interface so that the administrator can modify or supplement the corresponding operation.

In addition, the management server may output, again in the form of a simulation, an operation of the virtual collaborative robot edited through the editing interface so that the administrator can confirm the edited operation. That is, the management server may regenerate a new operation to be performed by the virtual collaborative robot based on the edited operation information and may visually simulate the regenerated operation on the GUI.

Further, when a selection signal is input by the administrator, the management server may convert operation information of the virtual collaborative robot edited through the editing interface into a test control command applicable to the collaborative robot.

At this time, in order to process operation information of the virtual collaborative robot, generated or modified through the editing interface, so as to be applicable to the actual collaborative robot, the management server may convert the operation information of the virtual collaborative robot into joint values of the collaborative robot based on an inverse kinematics algorithm.

As described above, although preferred embodiments of the present disclosure have been disclosed in the specification and drawings, it will be apparent to those skilled in the art that other modified examples based on the technical spirit of the present disclosure may be implemented in addition to the embodiments disclosed herein. Further, specific terms used in the specification and drawings are merely used in a general sense to easily explain the technical contents of the present disclosure and to assist understanding of the present disclosure, and are not intended to limit the scope of the present disclosure. Therefore, the above detailed description should be construed as illustrative in all respects and not restrictive. The scope of the present disclosure should be determined by reasonable interpretation of the appended claims, and all modifications within the equivalent scope of the present disclosure are included in the scope of the present disclosure.

### REFERENCE SIGNS LIST

100 collaborative robot

200 camera

300 management server

305 communication unit

310 input/output unit

315 collision detection unit

320 collision response unit

325 work recovery unit

330 monitoring unit

What is claimed is:

1. A method for automatic collision and overload detection and recovery of a collaborative robot, the method comprising:
determining, by a management server, whether a collision has occurred based on a torque load applied to the collaborative robot; and
controlling, by the management server, the collaborative robot according to whether the collision has been determined to have occurred.

2. The method of claim 1, wherein the determining comprises receiving a current value generated in at least one driving unit for rotating or moving a plurality of joints included in the collaborative robot, and estimating, based on the received current value, a torque load applied to the at least one driving unit.

3. The method of claim 1, wherein the determining comprises receiving, from a torque sensor installed at each joint of the collaborative robot, a torque load applied to each joint.

4. The method of claim 1, wherein the determining comprises determining that the collaborative robot has collided when a torque load of at least one joint among a plurality of joints included in the collaborative robot exceeds a preset value.

5. The method of claim 4, wherein the controlling comprises stopping operation of the collaborative robot when it is determined that the collaborative robot has collided.

6. The method of claim 4, wherein the controlling comprises, when it is determined that the collaborative robot has collided, identifying, among a plurality of joints included in the collaborative robot, a joint affected by the collision, and moving the identified joint by a preset distance in a direction opposite to a direction of movement at a time of the collision.

7. The method of claim 6, wherein the controlling comprises identifying, as the joint affected by the collision, a joint having a greatest torque load among the plurality of joints.

8. The method of claim 2, wherein the controlling comprises, when it is determined that the collaborative robot has collided, moving each of the plurality of joints included in the collaborative robot by a preset distance in a direction opposite to a direction of movement at a time of the collision.

9. The method of claim 2, wherein the controlling comprises, when it is determined that the collaborative robot has collided, cumulatively storing torque loads generated in each of the plurality of joints included in the collaborative robot, and predicting a maintenance timing for each of the plurality of joints based on the cumulatively stored torque loads.

10. A computer program recorded on a recording medium combined with a computing device including:
a memory;
a transceiver; and
a processor configured to process instructions resident in the memory,
for causing the processor to execute:
determining whether a collision has occurred based on a torque load applied to a collaborative robot; and
controlling the collaborative robot according to whether the collision has been determined to have occurred.
